(19) United States
(12) Patent Application Publication
(10) Pub. No.: US 2023/0162003 A1
(43) Pub. Date: May 25, 2023

(54) INFORMATION PROCESSING DEVICE, METHOD OF CONTROLLING SAME, PROGRAM, AND LEARNED MODEL

(71) Applicants: Kumiko ISHII, Tokyo (JP); Xin DU, Tokyo (JP)

(72) Inventors: Kumiko ISHII, Tokyo (JP); Xin DU, Tokyo (JP)

(21) Appl. No.: 17/913,222

(22) PCT Filed: Feb. 2, 2021
(86) PCT No.: PCT/JP2021/003815

§ 371 Date: Sep. 21, 2022

(30) Foreign Application Priority Data
Mar. 31, 2020 (JP) 2020-062808

(51) Int. Cl. G06N 3/0442; G06N 3/08

(52) U.S. Cl. CPC G06N 3/0442; G06N 3/08

(57) ABSTRACT

An objective of the present disclosure is to acquire embedding vectors in which features of targets fluctuating in price depending on dates are embedded. When a set of texts nᵢ released from a past date to a base date are input, a neural network outputs a classification y\hat{ }^{j}ₜ indicating whether the price of each target has increased or decreased since the previous date until the base date. An information processing device achieving the neural network trains a model including embedding vectors. That is, the information processing device extracts feature vectors n^{K}ᵢ and n^{V}ᵢ at two different levels from each text nᵢ released at each date, determines a weight α^{j}ᵢ, based on the inner product of the feature vector n^{K}ᵢ and an embedding vector sⱼ, determines a status m^{j}_{τ} by multiplying the other feature vector n^{K}ᵢ by the weight α^{j}ᵢ and taking the sum, and inputs the status m^{j}_{τ} to a classifier, which is caused to output a classification y\hat{ }^{j}ₜ.

### CROSS-REFERENCED APPLICATIONS

This is a National Phase application of International Application No. PCT/JP2021/003815, filed on Feb. 3, 2021, which claimed priority to Japanese Application No. 2020-062808, filed on Mar. 31, 2020, both of which are incorporated herein in their entireties by reference thereto.

### TECHNICAL FIELD

The present disclosure relates to a technology for acquiring an embedding vector in which a feature of a target that fluctuates in price depending on date and time is embedded.

### BACKGROUND ART

Regarding a target that fluctuates in price depending on date and time, such as a stock, an investment trust, a claim, futures, an option, commodity futures, and a spot commodity, a target name, a company related to the target, a situation related to the target, and the like are timely released by texts in disclosure materials, news, a social network service (SNS), or the like.

Studies for predicting whether the price of a target at a date and time t (for example, tomorrow) has increased or decreased with respect to the price of the target at a date and time t−1 immediately before the date and time t (for example, today), based on texts released at respective dates and times t−1, t−2, t−3, . . . before the date and time t, using deep learning and a neural net have been conducted (Non Patent Literature 1). However, performing such prediction is extremely difficult.

On the other hand, regarding technologies for optimizing a portfolio defining a ratio at which investment is allocated to respective targets, formulation based on relationships between targets has been made, and, for example, a technology for determining a portfolio, using covariances between stock prices as a risk matrix for stocks has been proposed (Non Patent Literature 2).

On the other hand, a technology of, when texts are to be carefully examined, using two feature vectors at different levels has been proposed (Non Patent Literature 3).

### CITATION LIST

### Non Patent Literature

Non Patent Literature 1: Z. Hu, W. Liu, J. Bian, X. Liu, and T. Liu, “Listening to chaotic whispers: A deep learning framework for news-oriented stock trend prediction”, WSDM 2018, pp. 261-269, https://arxiv.org/abs/1712.02136, 2018
Non Patent Literature 2: A. Miller, A. Fisch, J. Dodge, A. Karimi, A. Bordes, and J. Weston, “Key-Value Memory Networks for Directly Reading Documents”, Proceedings of the 2016 Conference on Empirical Methods in Natural Language Processing, Association for Computational Linguistics, pp. 1400-1409, https://www.aclweb.org/anthology/D16-1147, 10.18653/v1/D16-1147, November 2016
Non Patent Literature 3: Harry Markowitz, “Portfolio Selection”, The Journal of Finance, Vol. 7, No. 1, pp. 77-91, March 1952

### SUMMARY

### Technical Problem

Therefore, in order to express a feature of a target that fluctuates in price depending on date and time, a technology for acquiring an embedding vector in which the feature of the target is embedded, referring to texts released at various dates and times is expected.

When an embedding vector in which a feature of a target is embedded is acquired, it becomes possible to, using the embedding vector, optimize a portfolio representing an allocation to targets.

The present disclosure has been made to solve the above-described problem, and an objective of the present disclosure is to provide an information processing device, a method of controlling the same, a program, and a trained model that are suitable for acquiring an embedding vector in which a feature of a target that fluctuates in price depending on date and time is embedded.

### Solution to Problem

In the present disclosure, an information processing device achieves a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors into which features of the plurality of targets are respectively embedded, and

trains the model by:

determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and

inputting the determined statuses into a training device and causing the training device to output the classifications.

In addition, the information processing device according to the present disclosure can be achieved by a processor, such as a central processing unit (CPU) and a graphics processing unit (GPU), that a computer includes executing code included in a program recorded in a non-transitory computer-readable information recording medium, and the program can be transferred via a transitory communication medium, such as a computer communication network.

Further, the information processing device according to the present disclosure can be constructed as a dedicated electronic circuit or dedicated hardware by using a technology such as a field programmable gate array (FPGA) and an application specific integrated circuit (ASIC) and, with reference to a program recorded in a non-transitory computer-readable information recording medium as a blueprint, applying various conversions and processing.

### Advantageous Effects of the Disclosure

The present disclosure enables an information processing device, a method of controlling the same, a program, and a trained model that are suitable for acquiring an embedding vector in which a feature of a target that fluctuates in price depending on date and time is embedded to be provided.

### BRIEF DESCRIPTION OF DRAWINGS

FIG. 1 is an explanatory diagram illustrating a configuration of a neural network in the present embodiment;

FIG. 2 illustrates graphs comparing performance according to a result of experiment in which the neural network according to the present embodiment was tested with performances in other modes;

FIG. 3 illustrates graphs comparing a result of experiment in which portfolio optimization according to the present embodiment was performed with respect to the Wall Street Journal with experimental results in other modes;

FIG. 4 illustrates graphs comparing a result of experiment in which the portfolio optimization according to the present embodiment was performed with respect to Reuters & Bloomberg with experimental results in the other modes; and

FIG. 5 is an explanatory diagram illustrating an outline of an information processing device in the present embodiment.

### DETAILED DESCRIPTION OF PREFERRED EMBODIMENTS

An embodiment of the present disclosure is described below. The present embodiment is for explaining the present disclosure, not for limiting the scope of the claimed invention. Accordingly, it is possible for a person skilled in the art to employ an embodiment in which some or all of the elements of the embodiment of the present disclosure are replaced by equivalents thereof, which are also included in the scope of the present disclosure.

(Computer Achieving Neural Network)

A neural network according to the present embodiment is typically achieved by a computer executing a program. The computer is connected to various types of output devices and input devices and transmits and receives information to and from the devices.

A program to be executed in a computer can be distributed and sold by a server to which the computer is connected in a communicable manner, and, in addition thereto, it is also possible to record the program in a non-transitory information recording medium, such as a compact disk read only memory (CD-ROM), a flash memory, and an electrically erasable programmable ROM (EEPROM), and thereafter distribute, sell, and the like the information recording medium.

The program is installed in a non-transitory information recording medium, such as a hard disk, a solid state drive, a flash memory, and an EEPROM, that a computer has. Then, the information processing device in the present embodiment is to be achieved by the computer. In general, a CPU of a computer reads a program from an information recording medium to a random access memory (RAM) and interprets and executes code included in the program under the control of an operating system (OS) of the computer. However, in an architecture enabling mapping of an information recording medium into a memory space accessible by the CPU, explicit loading of a program into the RAM may sometimes be unnecessary. Note that various types of information required in a process of executing a program can be temporarily stored in the RAM.

Further, as described above, a computer preferably includes a GPU and more preferably includes a GPU for performing various types of image processing computation at high speed. Use of a GPU and a library, such as TensorFlow, enables a learning function and a classification function in various types of artificial intelligence processing to be used under the control of the CPU.

Note that it is also possible to, instead of achieving the information processing device of the present embodiment by a general-purpose computer, configure the information processing device of the present embodiment, using a dedicated electronic circuit. In this mode of embodiment, the program can be used as material for generating a wiring chart, a timing chart, and the like of the electronic circuit. In such a mode of embodiment, an electronic circuit satisfying a specification prescribed in the program is configured by an FPGA or an ASIC, and the electronic circuit functions as a dedicated device fulfilling the function prescribed in the program and achieves the information processing device of the present embodiment.

(Configuration of Neural Network)

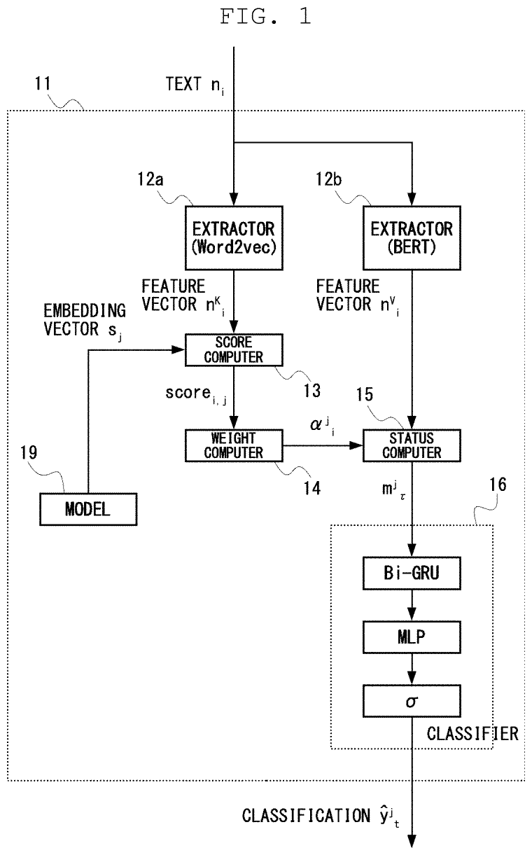

FIG. 1 is an explanatory diagram illustrating a configuration of a neural network in the present embodiment. Hereinafter, the description is made with reference to the present drawing.

A neural network 11 illustrated in the present drawing

is a neural network that, when a set of texts released at each of a plurality of dates and times from a past date and time before a base date and time to the base date and time are input,

outputs a classification indicating whether a price of each of a plurality of targets has increased or decreased since a date and time immediately before the base date and time until the base date and time, and

includes, in a model 19, a plurality of embedding vectors in which features of the plurality of targets are respectively embedded.

Hereinafter, the plurality of targets is denoted by integers j=1, . . . , J.

As a unit of date and time, an appropriate unit, such as 1 day, 12 hours, 1 hour, and 30 minutes, can be employed, and dates and times are denoted by integers in chronological order. Therefore, the date and time immediately before a date and time t is denoted by t−1.

When 1 day is employed as a unit of date and time, texts are grouped for each release date.

In a set Nₜ of texts that are released at a date and time τ, a plurality of texts is included. When one of the plurality of texts is denoted by nᵢ, nᵢ∈N_{τ} holds, and the number of texts that are released at a date and time τ is denoted by |N_{τ}|.

In the present embodiment, as input to the neural network 11, sets N_{t-d}, N_{t-d+1}, . . . , Nₜ of texts are employed.

When 1 day is employed as a unit of date and time, the neural network 11 is to accept as input

a set Nₜ of texts that are released on the base date and time t,

a set Nₜ₋₁ of texts that were released on the previous day of the base date and time t,

. . . , and

a set N_{t-d} of texts that were released on a past date and time t-d that is d days before the base date and time t.

On the other hand, as a price of a target at each date and time, various types of prices, such as an opening price, a closing price, a lowest price, a highest price, a median price, and an average price, of the target at the date and time can be used.

Hereinafter, a price of a target j at a date and time t is denoted by p^{j}ₜ. A price of the target j at a date and time t−1 immediately before the base date and time t is denoted by p^{j}ₜ₋₁.

In the present embodiment, as output from the neural network 11, the following classifications are employed:

y^{j}ₜ=1,(p^{j}ₜ≥p^{j}ₜ₋₁); and

y^{j}ₜ=0,(p^{j}ₜ<p^{j}ₜ₋₁).

When 1 day is employed as a unit of date and time, in the neural network 11, the classification y^{j}ₜ is 1 when the price of a target j at a date and time t has increased compared with the price on the previous day t−1 and is 1 when the price of the target j at the date and time t has decreased compared with the price on the previous day t−1. Note that, although, when the price of the target j at the date and time t has not changed from the price on the previous day t−1, the classification y^{j}ₜ is 1 according to the above-described definition, a definition as described below may be employed:

y^{j}ₜ=1,(p^{j}ₜ>p^{j}ₜ₋₁); and

y^{j}ₜ=0,(p^{j}ₜ≤p^{j}ₜ₋₁).

In the present embodiment, based on texts released during a period from a past date and time t-d to the base date and time t, increase and decrease in the price of a target at the base date and time t are classified. Therefore, the neural network 11 is not a predictor but a classifier. This is one of the features of the present embodiment.

Although, as a positive constant d to define a past date and time t-d from the base date and time t, an arbitrary constant can be employed, when 1 day is employed as a unit of date and time, setting d to approximately 4 enables a suitable result to be acquired, as described later.

When training of the neural network 11 is to be performed, suitability of output from the neural network 11 needs to be measured. For example, the suitability of output can be measured using cross-entropy or the like.

Herein, an output of the neural network 11 with respect to a target j at a date and time t, that is, a predicted value of the classification, is denoted by y^{\hat{ }j}ₜ, using a cone-shaped accent mark. Note that, in general, the accent mark is often placed over an alphabetical variable, as illustrated in the present drawing. Then, the training of the neural network 11 is equivalent to finding a function f(⋅) satisfying the following formula:

y^{\hat{ }j}ₜ=f({Nτ)τ∈_{[t-d,t]})

by optimizing the function in such a way that a difference between a predicted value y^{\hat{ }j}ₜ and a true classification y^{j}ₜ is reduced.

When periods 1 to T are respectively employed as the base date and time t and predicted values y^{\hat{ }j}₁, y^{\hat{ }j}₂, . . . , y^{\hat{ }j}_{T} obtained when the neural network 11 classifies a target j and true classifications y^{j}₁, y^{j}₂, . . . , y^{\hat{ }j}_{T} are compared with each other, cross-entropy l^{j} with respect to the target j for the periods is defined as follows:

CE^{j}=−(1/T)Σₜ₌₁^{T}[y^{j}ₜ log y^{\hat{ }j}ₜ+(1−y^{j}ₜ)log(1−y^{\hat{ }j}ₜ)].

Therefore, when the training of the neural network 11 is to be performed, overall cross-entropy:

CE=Σⱼ₌₁^{J}CEⱼ/J

can be employed as an evaluation function (loss function).

From each text nᵢ∈N_{τ} that is input to the neural network 11, feature vectors n^{K}ᵢ and n^{V}ᵢ at two different levels are extracted. The feature vectors are referred to as dual vector representation (DVR).

An extractor 12a is a component that extracts a feature vector n^{K}ᵢ from each text nᵢ, and the feature vector n^{K}ᵢ represents a feature of distributions of words or strings of words of a comparatively short length that appear in the text.

In the present embodiment, with respect to each word k that appears in a text nᵢ,

after finding a word embedding vector wₖ of the word k, using Word2vec, which is widely used in text processing using a neural network, and

computing a term frequency-inverse document frequency (TF-IDF) score γₖ=TFₖ·IDFₖ of the word k,

one feature vector n^{K}ᵢ of the text nᵢ is calculated by the following formula:

n^{K}ᵢ=Σₖγₖwₖ/Σₖwₖ.

In contrast, an extractor 12b is a component that extracts a feature vector n^{V}ᵢ from each text nᵢ, and the feature vector n^{V}ᵢ represents a feature of the whole text or a context represented by a string of words of a comparatively long length in the text.

In the present embodiment, the other feature vector n^{V}ᵢ of the text nᵢ is found by applying a bidirectional encoder representation from transformers (BERT) encoder, which is proposed in natural language processing, to the text nᵢ.

The extractors 12a and 12b include therein models to extract a feature of a text. As the models, models that have been trained on a specific corpus (for example, all collected texts or a whole corpus to which texts serving as input to the neural network 11 belong) may be used as it is, or a model that is, as a model included in the model 19 of the neural network 11, to be updated by advancing the training of the neural network 11 may be used.

In the example illustrated in the present drawing, it is assumed that, as the models included in the extractors 12a and 12b, existing models are reused and the models are different from the model 19 to be trained in the neural network 11.

The most important element in the model 19 to be trained in the neural network 11 is an embedding vector sⱼ in which a feature of a target j, that is, a feature representing a relationship between a price of the target j and a released text, is embedded. When a target j is a stock price, the embedding vector is referred to as a stock embedding vector.

When embedding vectors sⱼ and sₖ of targets j and k point in the same direction, both targets have the same feature based on the price and text in common.

A score computer 13, by taking the inner product of an embedding vector sⱼ in which a feature of a target j is embedded and one feature vector n^{K}ᵢ of a text, computes a score at a word level or a short phrase level:

score_{i,j}=n^{K}ᵢ·sⱼ.

Note that, instead of an inner product, a cosine similarity or a generalized inner product using an arbitrary function may be employed.

A weight computer 14 computes a weight α^{j}ᵢ put on a text nᵢ with respect to a target {j} as a relative weight with respect to the other texts released on the same date and time, using a softmax function, as follows:

α^{j}ᵢ=exp(score_{i,j})/Σ_{i′}exp(score_{i′,j}).

A status computer 14, based on a set of feature vectors

N^{V}_{τ}={n^{V}ᵢ|nᵢ∈N_{τ}},

computes a status m^{j}_{τ} of a target j at a date and time τ as follows:

m^{j}_{τ}=(1/|N^{V}_{τ}|)Σ[uᵢ∈N^{V}_{τ}]α^{j}ᵢuᵢ.

In the above formula, “Σ[uᵢ∈N^{V}_{τ}]” means “taking the sum with respect to uᵢ satisfying uᵢ∈N^{V}_{τ}”. The status m^{j}_{τ} of a target j at a date and time τ is referred to as a market vector.

In the above formula, |N^{V}_{τ}| denotes the number of elements in the set N^{V}_{τ} and is equal to the number of texts released at the date and time τ. In addition, Σ[uᵢ∈N^{V}_{τ}] means taking the sum with respect to a feature vector uᵢ satisfying uᵢ∈N^{V}_{τ}, and, in a general mathematical expression, uᵢ∈N^{V}_{τ} is written under Σ or as a subscript.

A status represented by a market vector m^{j}_{τ} serves as an input to a classifier 16.

The classifier 16 in the present application is achieved by a combination of a bidirectional gated recurrent unit (Bi-GRU), a multilayer perceptron (MLP), and a sigmoid function:

σ(x)=1/(1+exp(−x)).

That is,

h^{O}ₜ=GRU({m^{j}_{τ}}_{τ∈[t-d,t]}); and

y^{\hat{ }j}ₜ=σ(MLP(h^{O}ₜ)).

In addition to the above, re-weighting can be performed by applying a technology disclosed in Non Patent Literature 1 to the vector h^{O}_{τ} that the GRU outputs with respect to each date and time τ∈[t−d, t]). That is, using weight β_{τ}, classification is performed as follows:

h^{O}ₜ=GRU({m^{j}_{τ}}_{τ∈[t-d,t]});

h^{O}=Σ_{τ∈[t-d,t]}β_{τ}h^{O}ₜ; and

y^{\hat{ }j}ₜ=σ(MLP(h^{O})).

In the above formula, the weight β_{τ} is weight indicating to what extent a certain day is important in certain classification.

Performing re-weighting as described above enables overfitting in training to be avoided.

The training of the neural network 11 is performed in such a way that a difference between a prediction y^{\hat{ }j}ₜ of a classification that the classifier 16 outputs and a true classification y^{j}ₜ is reduced.

When the training is completed, embedding vectors s₁, . . . , sⱼ, . . . , s_{J} for targets 1, . . . , j, . . . , J are to be acquired, respectively, from the model 19.

The neural network 11 that has the trained model 19 is a neural network that infers a relationship between texts having been released up to a date and time t and increase or decrease in a price at the date and time t, not a neural network that predicts a price of a target at a future date and time.

However, the neural network 11 is capable of, based on a similarity between embedding vectors of two targets, determining a similarity between the two targets. Therefore, it is possible to achieve a technical effect that, using the trained model 19, a similarity between targets can be determined.

Further, as described later, the trained model 19 can also be used for portfolio optimization.

(Experiment of Classification Performance)

A result of an experiment performed on classification performance of the neural network 11 is described below. In the experiment, the unit of date and time is 1 day.

As texts, news articles from the Wall Street Journal (WSJ) published across 1 year, 3 years, and 16 years and headlines of news articles from Reuters & Bloomberg (R&B) published across 1 year, 3 years, and 7 years were employed.

As for targets, among 500 stocks in Standard & Poor's S&P 500 index, stocks that were mentioned in at least 100 different news articles were used. In addition, as an index, the S&P 500 index was used.

In this experiment, although a stock price is binarized based on a difference between prices on two consecutive days, the difference generally has a value around 0 most frequently, and, when the difference is close to 0, whether the price has increased or decreased becomes ambiguous in the first place. Accordingly, threshold values as described below were set with respect to a log return log(p^{j}ₜ)−log(p^{j}ₜ₋₁), and only stock prices on days when variation in the log return was greater than the threshold values were extracted.
WSJ . . . [−0.0053, 0.0079]; and
R&B . . . [−0.00587, 0.00684]

The reason why the threshold values are different between the increase side and the decrease side is that, in the period for which the experiment was conducted, the number of days when the economy was picking up and stock prices rose was greater than the number of days when stock prices declined.

Under the conditions described above, approximately 2600 articles and approximately 1200 articles from the WSJ and R&B were used for the processing, respectively.

The corpus of texts was divided into training/validation/test sets in the ratio of 0.6/0.2/0.2, and 10 trials were performed for different divisions and an average performance of the 10 trials was used as an experimental result.

An Adam optimizer was used with cosine annealing to train the neural network 11. An initial learning rate was set to 5×10⁻⁴, and mini-batch size was set to 64.

The training process was stopped when the value of the loss function with respect to the validation set no longer dropped, and subsequently a test for evaluation was performed.

From a news article text, two feature vectors are extracted. As described above, for the feature vector n^{K}ᵢ at the short phrase level, a word embedding vector acquired by Word2vec was employed, and the feature vector n^{V}ᵢ at the long phrase level was determined based on the TF-IDF score.

Note that the dimension of the feature vector n^{K}ᵢ is set to 64 and a Word2vec model was trained on the above-described corpus of article texts.

By, after having performed vectorization using a BERT encoder, executing principal component analysis (PCA), the dimension of the feature vector n^{V}ᵢ was reduced to 256.

The experiment was conducted by comparing the following four types of modes.

(1) Simple average: a mode in which a simple average is taken by neglecting the feature vectors at the short phrase level and setting weights as α^{j}ᵢ=1.

(2) Weighted average (WA): a mode in which an average is taken using weights computed from the stock-text inner products. It is assumed that a classifier for each stock is independent of the others.

(3) WA+classifier sharing (CS): a mode in which, in the above-described WA, a classifier is shared as with the present technology.

(4) WA+dual-vector representation: a mode in which weighting is performed using feature vectors at two levels. It is assumed that a classifier for each stock is independent of the others.

(5) WA+CS+dual-vector representation: a mode according to the above-described embodiment (proposed).

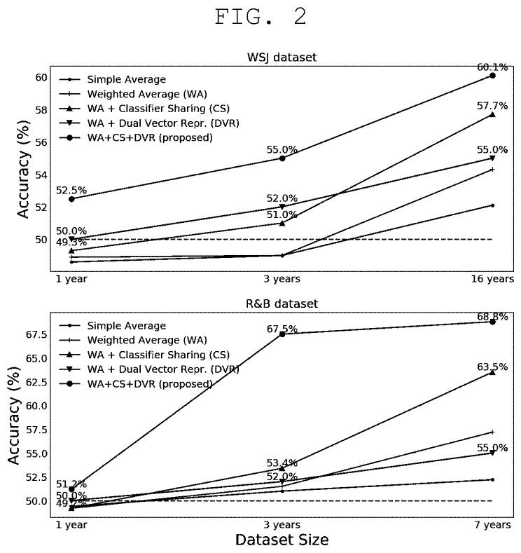

FIG. 2 illustrates graphs comparing performance according to a result of experiment in which the neural network according to the present embodiment was tested with performances in the other modes. Hereinafter, the description is made with reference to the present drawing.

As illustrated in the present drawing, in any methods, as the dataset size of texts becomes longer, the accuracy of classification improves. However, it is revealed that, for all dataset sizes, the above-described embodiment (proposed) can achieve an accuracy of classification of up to 68.8% and the accuracy of classification of the proposed method is substantially higher than those of the other four methods.

(Optimum Portfolio)

A mode in which a portfolio is optimized using embedding vectors included in the trained model 19 in the neural network 11 is described below.

As described above, portfolio optimization has been formulated by the technology disclosed in Non Patent Literature 3. First, a J-dimensional vector ω that represents a ratio at which assets are allocated to respective targets is considered. It is assumed that the vector ω is an identity matrix and satisfies the following formula:

ω^{T}ω=1.

Then, a risk R of the portfolio can be expressed by the following formula, using a risk matrix Σ:

R=ω^{T}Σω.

Then, the portfolio optimization is equivalent to finding co that minimizes the risk R.

When a J-dimensional vector r that represents mean returns of respective targets is considered, return E from the portfolio can be expressed as follows:

E=ω^{T}r.

In general, higher E means higher risk.

In Non Patent Literature 3, a covariance matrix is employed as the risk matrix Σ. That is, the risk matrix E is defined as follows:

Σ=Cov({rⱼ}ₜ)(j∈[1,J]).

However, since overwhelming noise in price movements of the targets prevents accurate simulation and dissemination of events that cause price movement by the texts is ignored, use of a covariance matrix as a risk matrix E does not provide excellent performance.

In contrast, in the present embodiment, using cosine similarities with respect to embedding vectors, (i, j)-elements in the risk matrix Σ are set as follows:

Σ_{i,j}=cos(sᵢ,sⱼ).

This definition is equivalent to employing a similarity matrix between targets as a risk matrix. Note that, since a similarity between the embedding vectors sᵢ and sⱼ is only required to be stored in an (i, j)-element Σ_{i,j} in the risk matrix Σ, an inner product, a generalized inner product, or the like may be employed, instead of the cosine similarity.

Gain E_{[b, e]} of a portfolio during a period [b, e] can be calculated, using a price p^{j}_{b} at a beginning time b of the period and a price p^{j}ₑ at an end time e of the period of a target j, as follows:

E_{[b,e]}=Eⱼ₌₁^{J}ωⱼ(p^{j}ₑ/p^{j}_{b}−1).

Calculating ω that minimizes the risk R=ω^{T}Σω with a desired value set to the gain E_{[b, e]} as a constraint condition enables optimization of the portfolio to be achieved.

(Experiment of Portfolio)

As described above, with respect to articles in respective years of each of 16 years of WSJ articles and 7 years of R&B articles, an expected annual return E was set to from 0.05 to 0.29 with 0.01 increments, and, after having calculated co that minimizes the risk, a real average return (averaged over years) was calculated for each expected annual return E.

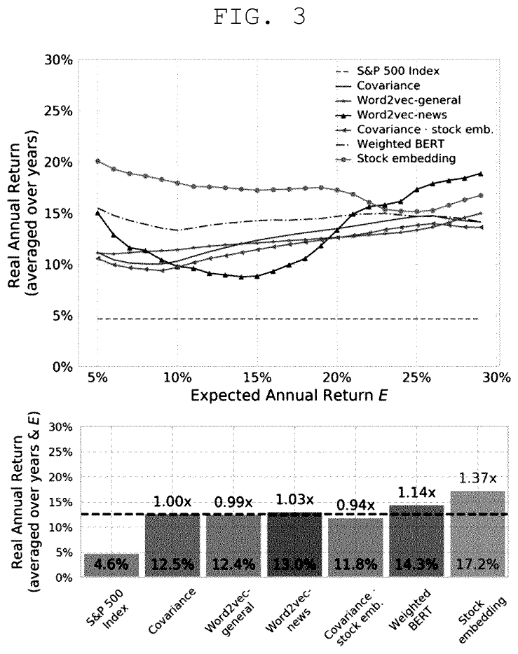

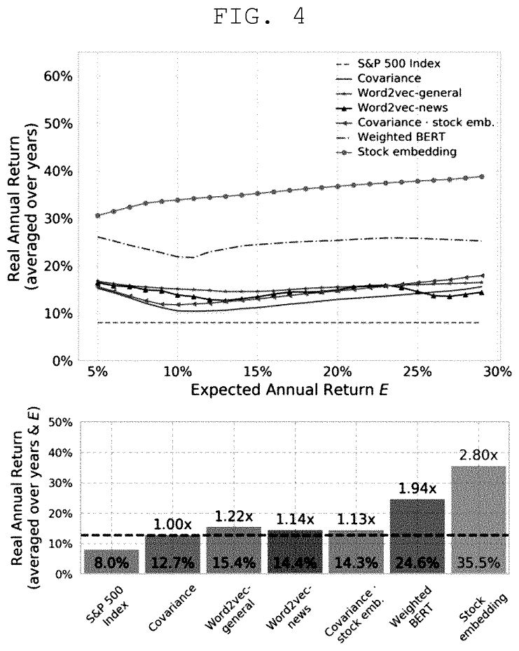

FIG. 3 is graphs comparing a result of experiment in which the portfolio optimization according to the present embodiment was performed with respect to the Wall Street Journal with experimental results in other modes. FIG. 4 is graphs comparing a result of experiment in which the portfolio optimization according to the present embodiment was performed with respect to Reuters & Bloomberg with experimental results in the other modes.

In the experiments, as targets for comparison with the present embodiment (Stock embedding), the following six types of definitions of the risk matrix were employed:
S&P 500 index (S&P 500 index);
covariance matrix of stock prices (Covariance);
variance representation acquired by Word2vec using an existing model (Word2vec-general);
variance representation acquired by Word2vec trained on news texts (Word2vec-news);
a weighted sum of BERT-based text representations using weights each of which is proportional to a frequency at which a stock is mentioned in a text (Weighted BERT); and
covariance of stock prices and embedding vectors according to the present embodiment (Covariance—stock emb.).

The graphs in the upper rows illustrate relationships of the real annual return with respect to the expected annual return, and the graphs in the lower rows illustrate average real annual returns.

As illustrated in FIG. 3, the above-described embodiment (Stock embedding) excellently performs in almost all cases. For example, while the performances of Covariance are 12.5% and 12.7%, the performances of the above-described embodiment (Stock embedding) are 17.2% and 35.5%, and it is revealed that a large return can be achieved.

Through the above-described experiment, effectiveness of the present embodiment was confirmed. Note that various conditions and parameters employed in the above-described experiment can be appropriately modified and a mode after such modification is also included in the technical scope of the present disclosure.

(Information Processing Device)

The above-described neural network 11 is capable of performing learning and classification and also capable of acquiring a trained model including embedding vectors by causing a computer to execute programs or causing an electronic circuit configured based on the programs to operate.

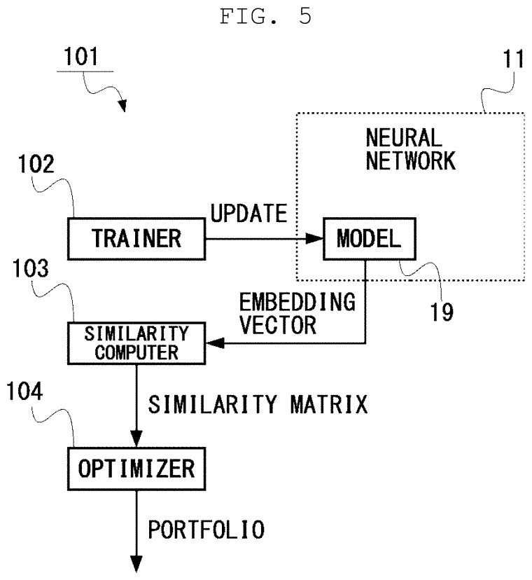

FIG. 5 is an explanatory diagram illustrating an outline of an information processing device in the present embodiment. Hereinafter, the description is made with reference to the present drawing.

As illustrated in the present drawing, an information processing device 101 includes a trainer 102. In addition, the information processing device 101 may include a similarity computer 103 and an optimizer 104, as optional elements.

In this configuration, the trainer 102 fulfills functions of performing training of the neural network 11 and updating the model 19 including embedding vectors.

On the other hand, the similarity computer 103 computes a similarity matrix representing similarities between targets, based on the trained model 19.

The optimizer calculates, based on the similarity matrix, a portfolio vector that minimizes a risk and represents an allocation of the targets.

(Conclusion)

As described in the foregoing, an information processing device according to the present embodiment

achieves a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, and includes

a trainer to train the model by:

determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and

inputting the determined statuses into a training device and causing the training device to output the classifications.

In addition, the information processing device according to the present embodiment can be configured such that

the one feature vector represents a feature of the each text at a word level, and

the other feature vector represents a feature of the each text at a context level.

In addition, the information processing device according to the present embodiment can be configured such that

the training device includes a bidirectional gated recurrent unit (Bi-GRU) and a multilayer perceptron (MLP).

In addition, the information processing device according to the present embodiment can be configured to further include

a similarity computer to compute, based on similarities between embedding vectors included in the trained model, a similarity matrix between pairs of targets in the plurality of targets.

In addition, the information processing device according to the present embodiment can be configured to further include

an optimizer to calculate a portfolio vector representing an allocation to the plurality of targets by minimizing a risk based on the computed similarity matrix.

A control method according to the present embodiment

controls an information processing device to achieve a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, and causes the information processing device to execute processing of

training the model by:

determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and

inputting the determined statuses into a training device and causing the training device to output the classifications.

In addition, a program according to the present embodiment

causes a computer to execute processing of achieving a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, and the program causes the computer to execute processing of

training the model by:

determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and

inputting the determined statuses into a training device and causing the training device to output the classifications.

In addition, a trained model according to the present embodiment is a trained model including an embedding vector learned by causing a computer to execute the program.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2020-062808, filed on Mar. 31, 2020, the entire disclosure of which is incorporated by reference herein.

### INDUSTRIAL APPLICABILITY

The present disclosure enables an information processing device, a method of controlling the same, a program, and a trained model that are suitable for acquiring an embedding vector in which a feature of a target that fluctuates in price depending on date and time is embedded to be provided.

### REFERENCE SIGNS LIST

11 Neural network
12a Extractor
12b Extractor
13 Score computer
14 Weight computer
15 Status computer
16 Classifier
19 Model
101 Information processing device
102 Trainer
103 Similarity computer
104 Optimizer

1. An information processing device to achieve a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, the information processing device comprising
a trainer to train the model by:
determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and
inputting the determined statuses into a training device and causing the training device to output the classifications.

2. The information processing device according to claim 1, wherein
the one feature vector represents a feature of the each text at a word level, and
the other feature vector represents a feature of the each text at a context level.

3. The information processing device according to claim 1, wherein the training device includes a bidirectional gated recurrent unit (Bi-GRU) and a multilayer perceptron (MLP).

4. The information processing device according to claim 1 further comprising a similarity computer to compute, based on similarities between embedding vectors included in the trained model, a similarity matrix between pairs of targets in the plurality of targets.

5. The information processing device according to claim 4 further comprising an optimizer to calculate a portfolio vector representing an allocation to the plurality of targets by minimizing a risk based on the computed similarity matrix.

6. A method of controlling an information processing device to achieve a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, the method causing the information processing device to execute processing of
training the model by:
determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and
inputting the determined statuses into a training device and causing the training device to output the classifications.

7. A program causing a computer to execute processing of achieving a neural network that, when a set of texts released at each of a plurality of dates and times from a past date and time before a base date and time to the base date and time are input, outputs a classification indicating whether a price of each of a plurality of targets has increased or decreased since a date and time immediately before the base date and time until the base date and time and includes, in a model, a plurality of embedding vectors in which features of the plurality of targets are respectively embedded, the program causing the computer to execute processing of
training the model by:
determining statuses of the plurality of targets at each of dates and times from the past date and time to the base date and time by:
extracting feature vectors at two different levels from each text released at the each of dates and times;
determining a weight for the each text, based on an inner product of one feature vector of the feature vectors extracted from the each text and each of the plurality of embedding vectors; and
multiplying the other feature vector of the feature vectors extracted from the each text by the determined weight of the each text and taking a sum; and
inputting the determined statuses into a training device and causing the training device to output the classifications.

8. A trained model comprising an embedding vector learned by causing a computer to execute the program according to claim 7.
